(19) United States
(12) Patent Application Publication
(10) Pub. No.: US 2025/0292036 A1
(43) Pub. Date: Sep. 18, 2025

(54) REAL-TIME LANGUAGE TRANSLATION AND CLARIFICATION SYSTEM FOR PRIVATE MULTILINGUAL CHAT CONVERSATIONS

(71) Applicant: CELLIGENCE INTERNATIONAL LLC, Gyaynabo, PR (US)

(72) Inventors: Pavan AGARWAL, Dorado, PR (US); Gabriel Albors Sanchez, San Juan, PR (US); Jonathan Ortiz Rivera, San Juan, PR (US)

(73) Assignee: CELLIGENCE INTERNATIONAL LLC, Guaynabo, PR (US)

(21) Appl. No.: 19/225,993

(22) Filed: Jun. 2, 2025

Related U.S. Application Data
(63) Continuation-in-part of application No. 18/135,703, filed on Apr. 17, 2023.
(60) Provisional application No. 63/332,205, filed on Apr. 18, 2022.

(51) Int. Cl. G06F 40/58; G06F 40/35

(52) U.S. Cl. CPC G06F 40/58; G06F 40/35

(57) ABSTRACT

Systems and methods are disclosed for real-time multilingual translation and contextual clarification within a private group chat interface. A computing system receives user-generated messages and translates them into each recipient's preferred language using a neural translation engine. When a term lacks a direct translation or is likely to cause confusion, a contextual clarification module generates a personalized explanation based on user profiles, language proficiency, and prior interactions. Clarifications are delivered privately to the intended recipient, preserving the conversational flow. An adaptive learning engine monitors user behavior across chat sessions, identifies patterns of confusion, and continuously refines the translation and clarification logic over time. The system may further include external API integration for idiomatic or cultural references and a user interface with interactive controls for viewing original message content and translation indicators.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD OF INVENTION

The present disclosure relates generally to natural language processing and machine translation systems, and more particularly to real-time, context-aware translation in chat-based communication platforms.

### BACKGROUND

As global collaboration and communication become increasingly common, users frequently engage in digital conversations with individuals who speak different native languages. While machine translation tools are available, existing solutions often lack integration within the chat interfaces themselves, resulting in fragmented workflows, delays, or a loss of conversational nuance.

Attempts to address these limitations have involved post-translation glossaries, inline translation bots, or external services. However, these approaches often fail to support real-time conversation flow or individualized clarification. They also do not adapt meaningfully over time based on user behavior or feedback, resulting in repeated confusion over similar terms or phrases.

Accordingly, there exists a need for an integrated, adaptive translation system capable of performing real-time language-to-language conversion within group chats, while also privately providing personalized clarifications for ambiguous or context-dependent terms. Such a system should be able to learn from ongoing user interactions to improve translation fidelity and user comprehension over time.

### SUMMARY

The present disclosure provides systems and methods for facilitating multilingual communication within a private group chat interface using real-time language translation, context-aware clarification, and adaptive learning mechanisms. The system receives user-generated messages and identifies both the source language and the preferred target language for each recipient. Messages are translated dynamically within the chat interface and presented to each user in their selected language. When the system detects a term or phrase that lacks a direct translation or is likely to be misunderstood, it may optionally prompt the sender for additional context, generate a clarification, and deliver that clarification privately to the recipient. Clarifications are personalized based on factors such as the recipient's language proficiency, prior clarification history, and domain familiarity.

To improve performance over time, the system includes an adaptive learning engine that monitors clarification behavior across multiple chat sessions and updates the translation and clarification logic accordingly. Repeated confusion patterns are identified and used to refine future message handling, ensuring that commonly misunderstood terms are automatically clarified in subsequent conversations. A language and contextual knowledge store may be updated to reflect new clarification patterns, idiomatic expressions, or domain-specific terminology. In some embodiments, the system may also access external APIs or third-party databases to retrieve cultural references or industry-specific definitions. The user interface may include controls that allow users to view the original untranslated message or access clarification content discreetly, without disrupting the group chat. These improvements enhance the accuracy, personalization, and fluidity of multilingual conversations in a chat-based environment, while maintaining a seamless and user-friendly experience.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating an exemplary system architecture for real-time language translation and contextual clarification in a multilingual group chat environment, according to an implementation of the disclosure.

FIG. 2 is a flowchart illustrating t message translation workflow for converting a user's message into a recipient's preferred language in real time, according to an implementation of the disclosure.

FIG. 3 is a flowchart illustrating a contextual clarification process for handling ambiguous or culturally specific terms within a translated message, according to an implementation of the disclosure.

FIG. 4 is a flowchart illustrating an adaptive learning workflow for refining translation and clarification logic based on patterns of user confusion over time, according to an implementation of the disclosure.

FIG. 5 is a user interface illustration depicting a multilingual group chat with translated message display, according to an implementation of the disclosure.

FIG. 6 illustrates an example computing system that may be used in implementing various features of embodiments of the disclosed technology.

Described herein are systems and methods for real-time multilingual translation and adaptive contextual clarification within a private group chat interface. The disclosed system delivers personalized translations, identifies potentially confusing terms, and provides private, recipient-specific clarifications. Over time, the system autonomously refines its language handling logic based on observed user behavior, ensuring more accurate and seamless communication across languages. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present embodiment relates to a system and method for facilitating real-time, multilingual communication within a private group chat interface. The disclosed system integrates neural machine translation, adaptive learning, and context-aware clarification logic to ensure that participants in a group conversation perceive messages in their preferred language, along with any necessary explanatory content. A key aspect of the system is its ability to deliver clarifications and definitions privately, without disrupting the flow of group dialogue. The system further includes self-learning components that adapt over time based on patterns of user confusion or clarification behavior, enabling increasingly accurate and nuanced translation tailored to conversational context.

Conventional systems for language translation in messaging environments often rely on static, one-size-fits-all models that fail to address the dynamic and context-rich nature of human conversation. These systems frequently lack the ability to perform real-time translation embedded within the messaging interface itself, leading to delays or fragmented user experiences. Moreover, traditional translation engines are typically literal in nature and unable to account for idiomatic expressions, cultural references, or domain-specific terminology. When ambiguous or untranslatable terms are encountered, conventional platforms provide no built-in mechanism for clarifying meaning, forcing users to either guess the intended message or seek clarification through disruptive follow-up messages. In group chat environments, such clarifications are often made publicly, which can interrupt the conversation flow and reveal confusion in ways that are socially or professionally undesirable. Critically, these systems do not learn from prior interactions, resulting in recurring translation errors or repeated misunderstandings across sessions.

The present embodiment introduces a number of technical improvements to address these limitations. A real-time translation engine is integrated directly into the chat interface, enabling instant conversion of user messages into each recipient's preferred language using transformer-based models optimized for conversational flow. Unlike traditional translation systems, the present embodiment includes a contextual clarification module capable of detecting when a term or phrase may lack a direct translation or be prone to misunderstanding. In such cases, the system may request additional context from the sender or generate a customized explanation delivered privately to the intended recipient. This private clarification mechanism preserves conversational continuity while providing individualized linguistic support. To further enhance performance, the system includes an adaptive learning engine comprising self-learning neural modules that analyze historical user interactions to identify patterns in confusion or clarification behavior. These modules autonomously refine translation strategies and explanation logic over time, resulting in a more accurate and personalized user experience. The system is designed to support multilingual group conversations in which users may be speaking different languages simultaneously, with each participant receiving translated and clarified messages tailored to their preferences and prior interactions. By combining real-time processing, contextual sensitivity, and adaptive intelligence, the disclosed system significantly improves the inclusiveness, accuracy, and usability of multilingual communication in chat-based environments.

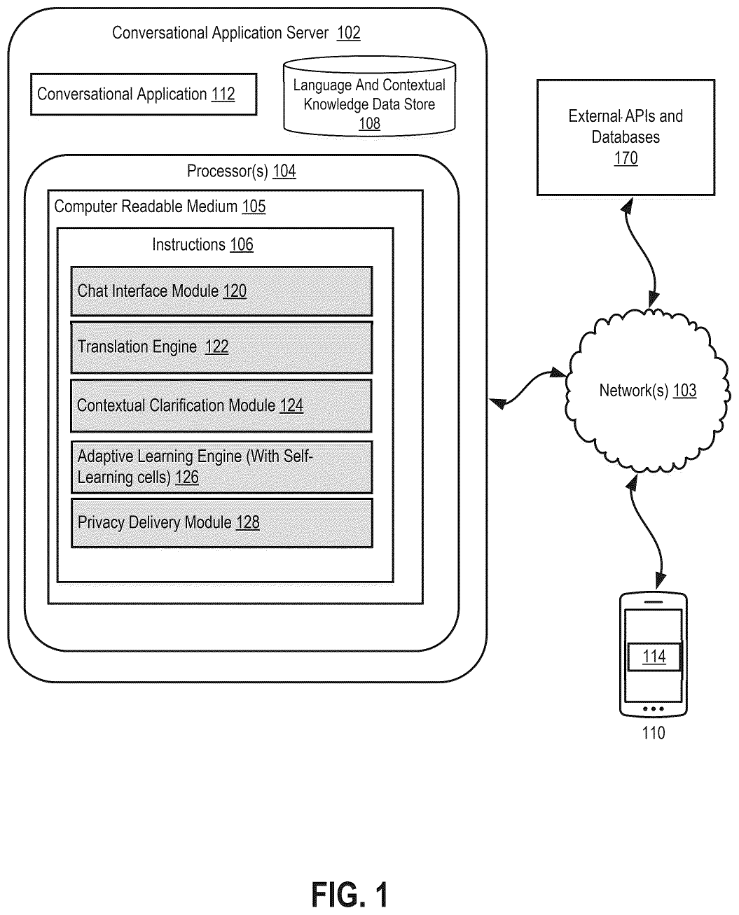

The following figure provides a high-level overview of the system architecture illustrating key modules and data flows between user devices and the server. FIG. 1 is a block diagram illustrating an exemplary system architecture for real-time translation and contextual clarification in a multilingual group chat system, according to an implementation of the disclosure. The system includes a Conversational Application Server 102 that executes a Conversational Application 112 and accesses a Language and Contextual Knowledge Data Store 108. The server comprises one or more processors 104 and a computer-readable medium 105 storing instructions 106. These instructions include a Chat Interface Module 120 configured to manage message exchanges in a group chat interface, a Translation Engine 122 configured to detect a source language and generate real-time translations into target recipient languages, and a Contextual Clarification Module 124 that detects ambiguous or untranslatable terms and generates personalized explanations. The system further includes an Adaptive Learning Engine 126, which incorporates self-learning cells to refine translation and clarification behavior over time based on user interactions, and a Privacy Delivery Module 128 that ensures clarifications are delivered discretely to each user. User Devices 110, such as smartphones 114, communicate with the server over one or more networks 103. The system may also interface with External APIs and Databases 170 to retrieve linguistic resources, cultural references, or integrate with third-party messaging platforms such as Zoom or WhatsApp.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The disclosed system operates within a modular, service-oriented architecture designed to support scalable, multilingual group chat interactions with context-aware translation and clarification. FIG. 1 provides a high-level system overview, showing key functional modules and data flows between components.

In an exemplary implementation, the system includes a conversational application server 102 configured to facilitate multilingual communication and contextual clarification within a private group chat interface. The server 102 executes a conversational application 112, which orchestrates the flow of messages between users, manages user preferences, and invokes language processing modules in real time. The server comprises one or more processors 104 and a computer-readable medium 105 that stores instructions 106 executable by the processors. These instructions include a chat interface module 120 configured to receive, display, and transmit user-generated chat messages across a plurality of user devices 110. The chat interface may include support for text entry, timestamping, message threading, and interface controls for translation and clarification interactions.

In the following sections, each module is described in further detail with reference to specific functions, workflows, and interface elements.

A translation engine 122 is configured to detect the source language of each incoming message and generate a translation in real time based on each recipient's target language preference. The system determines a user's target language by referencing a stored preference in the user's profile, which may be initially configured by the user, inferred from the device's locale settings, or dynamically updated over time based on behavior patterns detected by the adaptive learning engine 126. The translation engine may utilize a transformer-based neural language model fine-tuned for conversational phrasing and may access both internal and external linguistic resources to ensure contextual accuracy and cultural appropriateness. The system further includes a contextual clarification module 124 configured to detect terms or phrases in a message that may lack a direct translation or be prone to misunderstanding. In such cases, the module may generate context-aware explanations or prompt the sender to clarify intent. These clarifications are delivered in a manner that preserves the recipient's user experience and minimizes disruption to the broader conversation. To support continuous performance improvement, the system includes an adaptive learning engine 126 comprising self-learning neural modules, referred to herein as learning cells. These learning cells are configured to monitor user interactions across multiple chat sessions, including clarification requests, translation edits, and response delays, to identify patterns of confusion and autonomously refine translation and clarification logic over time. In some implementations, the adaptive learning engine may also adjust its behavior based on domain-specific language usage or individual user comprehension profiles. The privacy delivery module 128 ensures that clarifications, definitions, or alternate translations are delivered privately to the intended recipient, rather than being displayed publicly within the group chat. This preserves the conversational flow and maintains a discreet user experience, particularly in professional or sensitive communication settings.

User interaction with the system occurs via one or more user devices 110, which may include smartphones, tablets, or desktop clients equipped with communication software. Each user device 110 may include a display, a network interface, and a user-facing interface component 114 for interacting with the chat application. These devices connect to the conversational application server 102 over one or more networks 103, such as the internet or a cellular data network. In some implementations, the server 102 also accesses external APIs and databases 170 to augment its translation and clarification capabilities. These external resources may include third-party language models, culturally specific terminology databases, or integrated communication platforms such as Zoom, WhatsApp, or enterprise messaging tools. The integration of external systems enables the application to extend its multilingual functionality across broader communication ecosystems.

In some embodiments, the system may be deployed in a cloud-based environment with modular services accessible via secured APIs, enabling scalability and third-party integration.

The system further includes a language and contextual knowledge store 108, which serves as a centralized repository for linguistic, semantic, and user-specific data used by various components of the conversational application. This data store may include multilingual dictionaries, translation mappings, idiomatic expression libraries, domain-specific glossaries, and context-sensitive phrase associations used by the translation engine 122. The contextual clarification module 124 accesses the data store 108 to retrieve explanatory content for ambiguous terms or culturally dependent phrases, including usage examples or definitions tailored to the recipient's language and comprehension level. Additionally, the adaptive learning engine 126 contributes to and retrieves from the data store 108 as part of its ongoing refinement process, logging clarification requests, resolution outcomes, and commonly misunderstood terms. In some embodiments, the data store may include user-specific language profiles, historical message traces, and interaction metrics that inform the generation of personalized clarifications and translation strategies. The language and contextual knowledge store 108 may be maintained locally within the conversational application server 102 or distributed across a cloud-based infrastructure to enable scalable access and real-time updates across multiple user devices and group chat sessions.

User interaction with the system occurs via one or more user devices 110, which may include smartphones, tablets, or desktop clients equipped with communication software. Each user device 110 may include a display, a network interface, and a user-facing interface component 114 for interacting with the chat application.

In some embodiments, the system may be accessed through standard web browsers or existing messaging platforms, enabling compatibility with a wide range of client computing devices without requiring specialized software installation. The user device 110 may interact with the conversational application Server 102 via a dedicated mobile application, an embedded widget, or third-party chat interfaces, depending on deployment context. This design allows the translation and clarification functionality to be seamlessly integrated into existing communication workflows, minimizing user friction and ensuring broad accessibility across platforms.

In some embodiments, the system may access external APIs and databases 170 to augment translation and clarification functions. These third-party services may include linguistic corpora, domain-specific glossaries, multilingual sentiment interpretation tools, or cultural reference databases. For example, when encountering uncommon terminology or idiomatic expressions, the system may query external services to retrieve candidate meanings or contextual explanations. Integration with external messaging platforms, such as Zoom, WhatsApp, or enterprise collaboration tools, may also be facilitated via API-level connections, enabling users to benefit from the translation and clarification features even when operating outside of the native chat interface. Access to external APIs may be governed by authentication rules and data privacy policies to ensure secure and compliant operation.

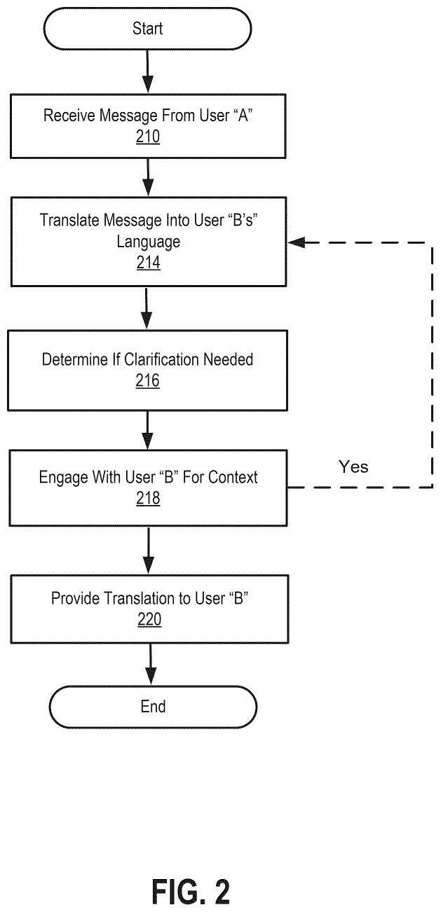

FIG. 2 is a flowchart illustrating a real-time message translation and clarification workflow in a multilingual group chat environment, according to an implementation of the disclosure. The process begins when a message is received from a first user, designated as user A. At step 210, the system receives the message and at step 214, the translation engine translates the message into the preferred language of a second user, user B. At step 216, the system determines whether clarification is needed by evaluating whether the message includes ambiguous or untranslatable terms. If clarification is necessary, the system proceeds to step 218, where the contextual clarification module engages with user B to obtain additional context or provide an explanation. In some implementations, the clarification loop may result in adjustments to the translated message by returning to step 214. At step 220, the finalized translation is delivered to user B. The process enables personalized, context-aware communication between users with different language preferences while preserving the continuity and flow of the conversation.

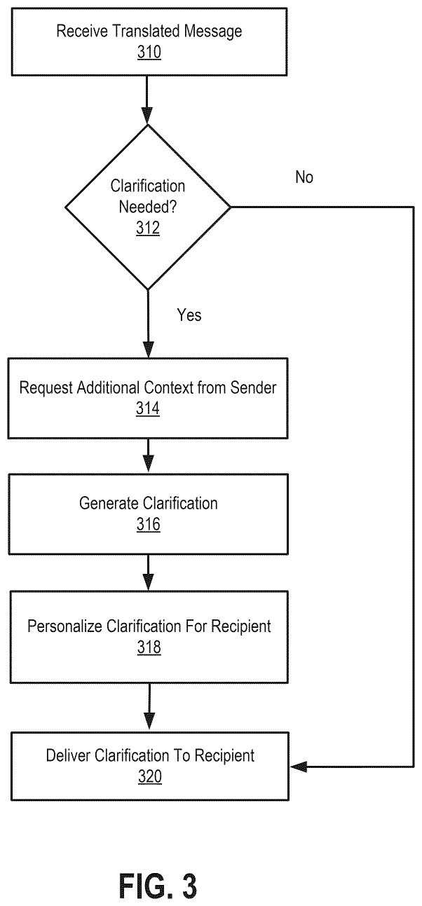

FIG. 3 is a flowchart illustrating an exemplary clarification workflow initiated when a translated message includes potentially ambiguous or culturally specific terms, according to an implementation of the disclosure. At step 310, the system receives a translated message that is intended for delivery to a recipient, such as user B. Before presenting the message to the recipient, the system evaluates whether clarification is needed (step 312), based on linguistic ambiguity, idiomatic usage, or a lack of direct translation. If clarification is not required, the system proceeds directly to step 320 to provide the translated message to user B. However, if clarification is needed, the system proceeds to step 314, where it may request additional context from the original sender, user A. This may include asking user A to select from a list of interpretations, provide a paraphrased version, or confirm intended usage. Once sufficient context is gathered, the system generates a contextual explanation or definition (step 314) and personalizes it for the recipient (step 316), taking into account user B's language proficiency, prior clarification history, and domain familiarity. The clarification is then delivered privately to the recipient in step 318, ensuring that the explanation does not disrupt the broader group conversation. Finally, the clarified or contextually enhanced translation is presented to user B in step 320.

For example, if user A sends a message in Spanish stating, “Tenemos un unicornio en camino,” the literal translation, “We have a unicorn on the way,” may confuse user B if read outside a business context. The system detects that “unicorn” is a term with multiple meanings, prompts user A for clarification, and learns that it refers to a high-value startup. The system then generates a clarification stating that “unicorn” refers to a privately held startup company valued at over one billion dollars, personalizes the explanation for user B's reading level, and delivers it privately along with the translated message. This workflow ensures that translated messages preserve their intended meaning and nuance across linguistic and cultural boundaries.

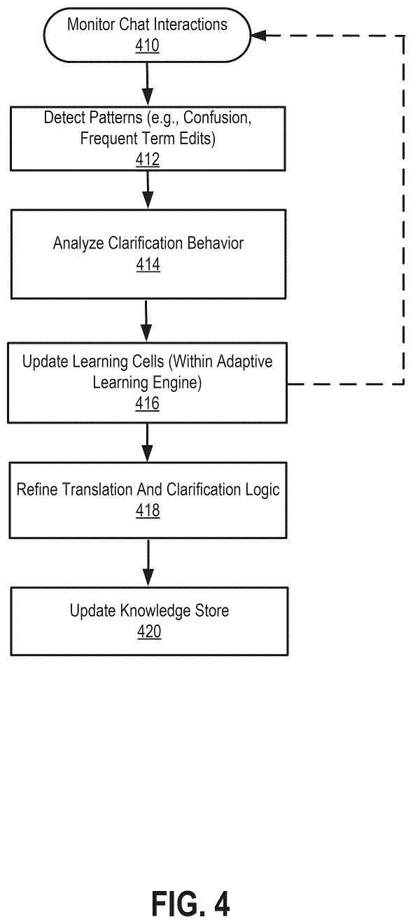

FIG. 4 is a flowchart illustrating an adaptive learning workflow performed by the system to refine translation and clarification logic over time, according to an implementation of the disclosure. At step 410, the system monitors ongoing chat interactions between users, capturing data associated with user input, clarification requests, message edits, delivery timing, and interaction patterns. At step 412, the system detects patterns indicative of comprehension issues or inefficiencies in translation quality. Such patterns may include repeated clarification requests for a specific term, delayed response times, frequent rephrasing of received messages, or high incidence of manual message edits. At step 414, the system analyzes clarification behavior in greater detail to determine which terms, phrases, or linguistic structures are consistently associated with confusion. This analysis may include identifying user segments most affected, linguistic categories involved (e.g., idioms, cultural references, technical jargon), or correlations with domain context.

At step 416, the system updates one or more learning cells within the adaptive learning engine 126. These learning cells represent autonomous, self-training components that adjust translation weights, disambiguation heuristics, or clarification triggers based on accumulated interaction data. In some implementations, learning cells may also tune thresholds for initiating clarification requests or identifying when a clarification should be personalized based on user behavior. At step 418, the refined logic is propagated to the translation engine 122 and the contextual clarification module 124, improving their ability to anticipate and resolve linguistic ambiguities in future interactions. At step 420, the system updates the language and contextual knowledge store 108 with newly derived clarifications, observed clarification patterns, or learned user-specific preferences, thereby expanding the store's utility for future translation and personalization operations. The process then loops back to step 410, allowing the system to continuously observe and improve performance over time.

For example, suppose multiple users in multilingual business chats repeatedly request clarification when encountering the Spanish term “PYME.” The system detects this recurring confusion and analyzes that it often arises in cross-cultural exchanges involving English-speaking users unfamiliar with the abbreviation. The learning cells are updated to flag “PYME” as a high-frequency clarification candidate. In subsequent sessions, when a Spanish-speaking user sends “PYME,” the system automatically generates a personalized clarification-such as “This refers to a small-to-medium enterprise (SME) in Spanish business contexts”—and delivers it to English-speaking recipients along with the translated message. This continual learning and refinement process allows the system to reduce future ambiguity and improve multilingual comprehension with minimal user intervention.

In some implementations, the system leverages prior adaptive learning outcomes to autonomously identify and clarify commonly misunderstood terms in real time, without requiring an explicit trigger or prompt from the user. When a term has been previously flagged as a frequent source of confusion-either globally or for a specific recipient—the system may automatically intervene and generate a clarification based on stored context in the language and contextual knowledge store 108. These automatic clarifications are delivered privately to the intended recipient using the privacy delivery module 128 and are tailored to the recipient's language proficiency, prior clarification history, and communication patterns. For example, when two users discuss a technical term such as “zero-knowledge proof” that has previously generated confusion in similar contexts, the system may autonomously send each participant a brief explanation suited to their domain familiarity and preferred language. This allows the conversation to proceed without interruption while enhancing understanding on a personalized basis.

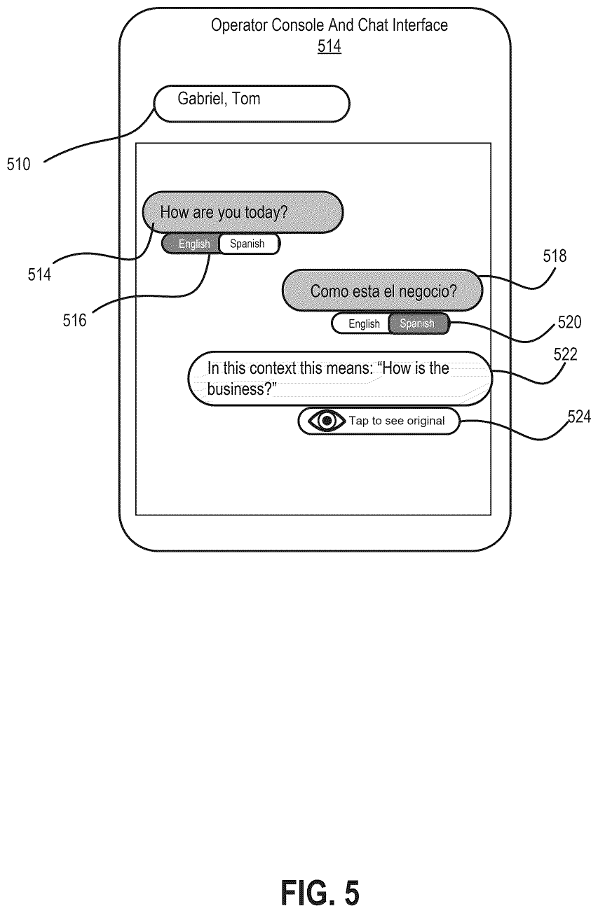

An example user interface may be configured to provide users with a visualization of translated message bubbles in a multilingual private group chat, as illustrated in FIG. 5. In this example, messages originally authored in one language (e.g., Spanish) are translated and rendered in the recipient's preferred language (e.g., English) within the chat bubble 514. A translation indicator 516 may appear within or adjacent to the message bubble to signify that a translation has occurred. The system may also include an interactive control 524, such as an eye icon, which when selected by the recipient temporarily reveals the original untranslated message for a limited duration. This enables users to compare the translated message with the original content without disrupting the flow of conversation. In certain implementations, language preference selectors or indicators 520 are presented alongside each message or participant profile, enabling seamless language switching or multi-language comprehension within the same group chat. The illustrated interface demonstrates how the translation and clarification features of the system are delivered visually and interactively, preserving message integrity and readability across languages while supporting a fluid, user-personalized experience.

FIG. 5 is a user interface illustration depicting a multilingual group chat environment with real-time translation and contextual clarification features, according to an implementation of the disclosure. The illustrated interface 510 represents a messaging environment such as an operator console or a user-facing chat application. Within the interface, user-generated messages are displayed in message bubbles, including a translated message 514 originally authored in a different language. Each translated message may be accompanied by one or more language tags 516 indicating the source and target languages, allowing recipients to understand that the message has been translated. In the illustrated example, a subsequent message 518 is authored in Spanish by another participant. The system identifies this as a candidate for translation and displays a translated version to a recipient, again accompanied by source and target language indicators 520.

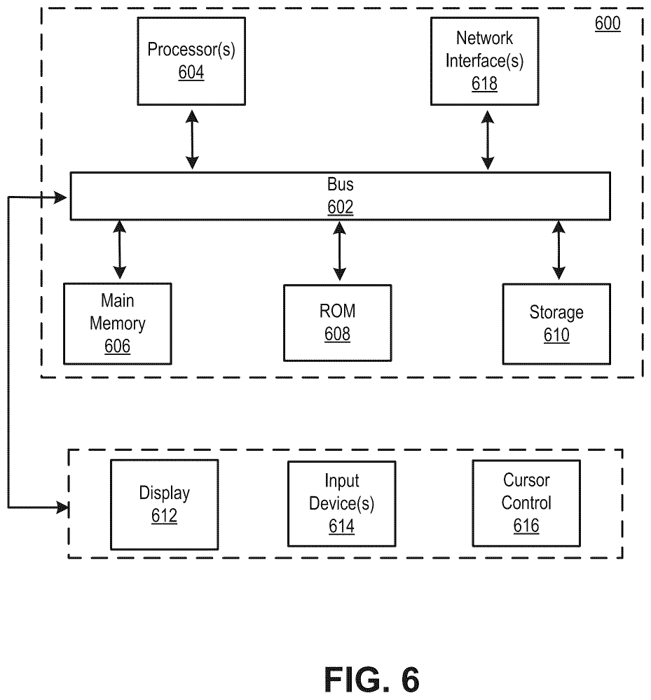

In some embodiments, when a translated message includes a term or phrase with no direct equivalent in the recipient's language, the system may generate a contextual clarification 522. This clarification may be displayed inline, as shown, or as a separate tooltip, side-thread, or overlay depending on user preference or interface constraints. The clarification is personalized to the recipient based on language proficiency, prior interactions, and domain familiarity, and is delivered privately to avoid disrupting the group chat. In the illustrated example, the clarification explains that the phrase “Como esta el negocio?” in this context means “How is the business?”-thereby preserving the sender's intent. In some implementations, a control 524, such as an icon with an “eye” symbol, allows the user to view the original untranslated message temporarily. This enables the recipient to compare the translation with the original input when desired, supporting transparency and bilingual learning. FIG. 5 illustrates how the system facilitates real-time multilingual interaction, adaptive explanation, and private clarification delivery within a unified chat interface.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 6. Various embodiments are described in terms of this example computing module 600. After reading this description, it will become apparent to a person skilled in the relevant art how to implement the technology using other logical circuits or architectures.

FIG. 6 illustrates an example computing module 600, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally. The bus 602 may also be connected to other components such as a display 612, input devices 614, or cursor control 616 to help facilitate interaction and communications between the processor and/or other components of the computing module 600.

Computing module 600 might also include one or more memory modules, simply referred to herein as main memory 606. For example, preferably random-access memory (RAM) or other dynamic memory might be used for storing information and instructions to be executed by processor 604. Main memory 606 might also be used for storing temporary variables or other intermediate information during execution of instructions to be executed by processor 604. Computing module 600 might likewise include a read only memory (“ROM”) 608 or other static storage device 610 coupled to bus 602 for storing static information and instructions for processor 604.

Computing module 600 might also include one or more various forms of information storage devices 610, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 600.

Computing module 600 might also include a communications interface or network interface(s) 618. Communications or network interface(s) interface 618 might be used to allow software and data to be transferred between computing module 600 and external devices. Examples of communications interface or network interface(s) 618 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 618 might typically be carried on signals, which can be electronic, electromagnetic (which includes optical) or other signals capable of being exchanged by a given communications interface. These signals might be provided to communications interface 618 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 606, ROM 608, and storage unit interface 610. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for facilitating multilingual communication within a private group chat, comprising:
receiving, by a computing system, a message composed by a first user within a group chat interface;
identifying, by the computing system, a source language of the message and a target language for a second user based on a stored user profile associated with the second user;
translating, in real time, the message into the target language;
determining whether the translated message includes a term lacking a direct translation or likely to cause confusion;
wherein the term is identified by:
optionally prompting the first user to provide additional context;
generating a context-specific explanation based on the original message and user-specific parameters;
personalizing the explanation based on the second user's language proficiency, clarification history, or domain familiarity; and
delivering the explanation privately to the second user within the chat interface;
delivering the translated message to the second user;
monitoring clarification behavior across a plurality of chat sessions to detect recurring confusion patterns; and
updating translation and clarification logic based on the detected patterns using an adaptive learning engine.

2. The method of claim 1, wherein translating the message comprises applying a transformer-based neural language model fine-tuned for conversational input.

3. The method of claim 1, wherein the step of generating a context-specific explanation further comprises retrieving cultural or idiomatic reference data from one or more external databases or APIs.

4. The method of claim 1, wherein prompting the first user to provide additional context comprises presenting a selectable clarification prompt inline within the sender's chat interface.

5. The method of claim 1, wherein delivering the explanation privately to the second user comprises rendering a tooltip, overlay, or sidebar annotation that is hidden from other participants in the group chat.

6. The method of claim 1, wherein personalizing the explanation comprises adjusting linguistic complexity based on the second user's language proficiency level and previously recorded clarification events.

7. The method of claim 1, further comprising displaying, adjacent to the translated message, a visual translation indicator selected from a language tag, flag icon, or annotation marker.

8. The method of claim 1, further comprising receiving input from the second user selecting a control to temporarily reveal the original untranslated message.

9. The method of claim 1, wherein updating the translation and clarification logic includes modifying a language and contextual knowledge store to record frequently misunderstood terms and associated resolutions.

10. A computer-implemented system for facilitating multilingual communication in a private group chat environment, comprising:
chat interface module configured to receive and display user-generated messages from a plurality of participants;
a translation engine configured to:
identify a source language of each message;
determine a target language for each recipient based on a stored user profile; and
translate the message into the target language in real time;
a contextual clarification module configured to:
detect, within a translated message, a term lacking a direct translation or likely to cause confusion;
generate a context-specific explanation based on the original message and one or more user profiles; and
deliver the explanation privately to a corresponding recipient;
an adaptive learning engine comprising one or more self-learning components configured to:
monitor clarification behavior over a plurality of chat sessions;
identify patterns of user confusion associated with particular terms or phrases; and
refine the operation of the translation engine and the contextual clarification module over time; and
a privacy delivery module configured to transmit the context-specific explanation to the recipient in a manner that is hidden from other participants in the group chat.

11. The system of claim 10, wherein the AI voice engine is further configured to synthesize speech in a voice model corresponding to a real human representative.

12. The system of claim 10, wherein the translation engine uses a transformer-based neural network trained on conversational language corpora.

13. The system of claim 10, wherein the contextual clarification module is further configured to prompt a sender of the original message to provide additional context when a potentially ambiguous term is detected.

14. The system of claim 10, wherein the context-specific explanation is generated using recipient-specific parameters comprising language proficiency level, clarification history, and domain familiarity.

15. The system of claim 10, wherein the explanation is delivered as a visual overlay selected from one of: a tooltip; a side thread; or an inline annotation rendered within the recipient's user interface.

16. The system of claim 10, wherein the privacy delivery module is configured to restrict visibility of the clarification to a single recipient within a multi-user group chat session.

17. The system of claim 10, wherein the adaptive learning engine is configured to update a shared language and contextual knowledge store with terms or phrases associated with prior clarification events.

18. The system of claim 10, further comprising an external data integration module configured to access one or more external APIs or databases for retrieving cultural, idiomatic, or industry-specific reference content.

19. The system of claim 10, wherein the chat interface module further includes an interactive control enabling a recipient to temporarily reveal the original untranslated version of a translated message.

20. The system of claim 10, wherein the translation engine is further configured to render a translation indicator adjacent to each translated message to visually signal that the displayed content differs from the original.

21. The system of claim 10, wherein the adaptive learning engine detects repeated clarification requests for a particular term and automatically generates future clarifications without additional prompts.
